(19) United States
(12) Patent Application Publication
(10) Pub. No.: US 2022/0216473 A1
(43) Pub. Date: Jul. 7, 2022

(54) SMALL FORM-FACTOR BATTERY WITH HIGH POWER DENSITY

(71) Applicant: INCUBE LABS, LLC, San Jose, CA (US)

(72) Inventors: Mir A. IMRAN, Los Altos Hills, CA (US); Radia Abdul WAHAB, San Jose, CA (US); Chang Jin ONG, San Jose, CA (US)

(73) Assignee: INCUBE LABS, LLC, San Jose, CA (US)

(21) Appl. No.: 17/703,538

(22) Filed: Mar. 24, 2022

Related U.S. Application Data
(63) Continuation of application No. PCT/US2020/052526, filed on Sep. 24, 2020.
(60) Provisional application No. 62/905,950, filed on Sep. 25, 2019.

(51) Int. Cl. H01M 4/54; H01M 4/62; H01M 10/04; H01M 4/38; H01M 50/121

(52) U.S. Cl. CPC H01M 4/54; H01M 4/622; H01M 2004/021; H01M 4/38; H01M 50/121; H01M 10/04

(57) ABSTRACT

A base cell structure includes a containment ring defining an opening extending therethrough. An inner wall of the containment ring defines a perimeter limit of a base cell volume. The containment ring provides a liquid-impermeable casing at the perimeter limit. A first set of active particles is disposed in the base cell volume of a first base cell structure to form an anode cell. A second set of active particles is disposed in the base cell volume of a second base cell structure to form a cathode cell. The anode cell and the cathode cell are assembled together with a separator disposed between. Two electrode plates are disposed on the assembly, one adjacent to the anode cell and one adjacent to the cathode cell, to respectively provide an anode electrode plate and a cathode electrode plate which are disposed on opposite outer sides of the assembly.

### CROSS-REFERENCE TO RELATED APPLICATIONS

This application is a continuation of International Application No. PCT/US2020/052526 filed on Sep. 24, 2020, which claims the benefit of U.S. Provisional Patent Application No. 62/905,950 filed on Sep. 25, 2019 and titled SMALL FORM-FACTOR BATTERY WITH HIGH POWER DENSITY, which are incorporated herein by reference in their entireties.

### BACKGROUND

Field. Embodiments of the present description relate to a battery. More specifically, embodiments of the present description relate to batteries and methods for manufacturing batteries having a small form factor and high capacity per unit volume.

In many applications, particularly those for use in small or difficult-to-navigate environments, it is desirable to have portable power sources (e.g., batteries) that have small form factors. However, maintaining battery capacity while decreasing the battery size is a continuing challenge. Furthermore, methods of manufacturing batteries with small form factors present numerous challenges.

### BRIEF SUMMARY

Embodiments of the present description provide devices, systems, and methods of manufacture for a small form factor battery with high capacity. The battery includes at least one anode and at least one cathode.

In an aspect of the present description, the battery is constructed of a multi-layer structure with active components including active particles.

In an embodiment, the active particles are ultra-fine. Nanopowders having average active particle sizes of less than 500 nm may be used to form the active components. The active particles are highly compacted as present in the manufactured battery.

In an embodiment, a base cell structure includes a containment ring defining an opening extending through the containment ring. The containment ring may have an annular shape. An inner wall of the containment ring around the opening defines a perimeter limit of a base cell volume. The containment ring provides a liquid-impermeable casing at the perimeter limit of the base cell volume. A first set of active particles is disposed in the base cell volume of a first base cell structure to form an anode cell. A second set of active particles is disposed in the base cell volume of a second base cell structure to form a cathode cell. The anode cell and the cathode cell are assembled together with a separator disposed between. Two electrode plates are disposed on the assembly, one adjacent to the anode cell and one adjacent to the cathode cell, to respectively provide an anode electrode plate and a cathode electrode plate which are disposed on opposite outer sides of the assembly.

In an embodiment, the cathode containment ring and/or the anode containment ring includes a polymeric layer that provides a moisture barrier while being biochemically inert and chemically resistant.

In an embodiment, a base cell structure includes a ring-shaped laminate of a containment ring and an adhesive layer on each side of the containment ring. An inner wall of the ring-shaped laminate defines a perimeter limit of the base cell volume.

In an embodiment, a base cell structure defines a base cell volume which can be filled with active particles to form an anode cell or to form a cathode cell. Said in another way, an anode cell is a base cell structure containing particles associated with an anode, and the anode cell defines an anode cell volume in which the active particles are disposed; similarly, a cathode cell is a base cell structure containing active particles associated with a cathode, and the cathode cell defines an anode cell volume in which the active particles are disposed.

In an embodiment, the battery is constructed as a dry assembly and includes one or more openings to allow for injection or infusion of an electrolytic solution into the battery subsequent to construction of the dry assembly. For convenience, the anode cell and the cathode cell are referred to herein respectively as the anode and the cathode after electrolyte has been added.

In an embodiment, electrolyte may be added after a period of storage of the dry assembly, to preserve shelf life.

In an embodiment, the active particles contained within the anode cell and the active particles contained within the cathode cell have an average particle size of less than 1 μm.

In an embodiment, the active particles contained within the anode cell and the active particles contained within the cathode cell have an average particle size of less than 500 nm.

In an embodiment, the active particles contained within the anode cell and/or the cathode cell have an average particle size of less than 100 nm.

In an embodiment, the active particles contained within the anode cell and/or the cathode cell have an average particle size of less than 50 nm.

In an embodiment, the active particles contained within the anode cell include silver oxide, and the active particles contained within the cathode cell include zinc.

In an embodiment, the active particles contained within the cathode cell include a polymeric binder. An example of a polymeric binder is polyethylene oxide.

In an embodiment, the active particles contained within the cathode cell include 90%-99% zinc with the remainder of the active particles being a polymeric binder.

In an embodiment, the battery is a high-drain silver oxide battery having a cathode including a zinc nanopowder with an average particle size of less than 100 nm and an anode including a silver oxide nanopowder with an average particle size of less than 500 nm.

In an embodiment, a total particulate mass of the anode and cathode active particles is equal to or less than 4 mg, and the inner walls of the containment rings or ring-shaped laminates of the anode and cathode (defining the respective cell volumes) have a height of approximately 1.27 mm (or about 0.05 in) and a measurement (e.g., diameter) across the respective cell volume of approximately 3.81 mm (or about 0.15 in).

In an embodiment, a total particulate mass of the anode and cathode active particles is equal to or less than 4 mg, and the inner walls of the containment rings or ring-shaped laminates of the anode and cathode (defining the respective cell volumes) have a height of approximately 101 μm (or about 0.004 in) and a measurement (e.g., diameter) across the respective cell volume of approximately 3.81 mm (or about 0.15 in).

In an embodiment, a particulate mass of each of the anode and cathode active particles is equal to or less than 4 mg, and the inner walls of the containment rings or ring-shaped laminates of the anode and cathode (defining the respective cell volumes) have a height of approximately 101 μm (or about 0.004 in) and a measurement (e.g., diameter) across the respective cell volume of approximately 3.81 mm (or about 0.15 in).

In an embodiment, an adhesive layer is disposed on opposing sides of the cathode containment ring and opposing sides of the anode containment ring. The adhesive layer promotes bonding of the cathode containment ring and anode containment ring to respective sides of the separator (e.g., a thin-film separator) and respective cathode and anode electrode plates. The various bonds may be made substantially concurrently on the assembly as a unit, or may be made in a series of steps during manufacture.

In an embodiment, a heat-activated adhesive layer is disposed on opposing sides of the cathode containment ring and opposing sides of the anode containment ring. The heat-activated adhesive layer promotes bonding of the cathode containment ring and anode containment ring to respective sides of the thin-film separator and respective cathode and anode electrode plates. The various bonds may be made substantially concurrently by applying heat to the assembly as a unit, or may be made in a series of steps by applying heat to portions of the assembly separately.

In an embodiment, a pressure-activated adhesive layer is disposed on opposing sides of the cathode containment ring and opposing sides of the anode containment ring. The pressure-activated adhesive layer promotes bonding of the cathode containment ring and anode containment ring to respective sides of the thin-film separator and respective cathode and anode electrode plates. The various bonds may be made substantially concurrently by applying pressure to the assembly as a unit, or may be made in a series of steps by applying pressure to portions of the assembly separately.

In an embodiment, an insulative encapsulating layer having a chemically resistive adhesive on one side may be attached to each electrode plate. Each insulative encapsulating layer is larger than the electrode plate such that, after adding electrolyte to the battery, a periphery of the battery can be sealed by coupling the insulative encapsulating layers (which overlap) to each other.

In an embodiment, end caps are positioned adjacent to the electrode plates. In an embodiment, the end caps are larger than the electrode plates such that the end caps may be bent over and formed around a remainder of the battery to encapsulate the battery. In an embodiment, rather than use the end caps to form an encapsulant, a separate encapsulant is applied over the end caps and over a remainder of the battery.

In an embodiment, the anode electrode plates and/or the cathode electrode plates include nickel, the adhesive layers are heat-activated and include ethylene-vinyl acetate (EVA), and the separator includes Cellophane P00.

In an embodiment, the form factor of the battery has an outer perimeter diameter of less than 5.08 mm (or about 0.20 in) and a thickness of less than 0.38 mm (or about 0.015 in).

In an embodiment, a small form factor battery according to an embodiment of the present disclosure is manufactured by: providing a first containment ring having an inner perimeter and height together defining a first cell volume, disposing adhesive layers on opposing sides of the first containment ring and disposing a first electrode plate adjacent to one of the adhesive layers; filling active particles into the first cell volume; providing a second containment ring having an inner perimeter and height together defining a second cell volume, disposing adhesive layers on opposing sides of the second containment ring and disposing a second electrode plate adjacent to one of the adhesive layers; filling active particles into the second cell volume; and assembling the first containment ring and the second containment ring with their respective adhesive layers on opposing sides of a separator such that the first electrode plate and the second electrode plate are on opposing sides of the assembly.

In an embodiment, a small form factor battery according to an embodiment of the present disclosure is manufactured by: providing a first ring-shaped laminate including a first containment ring having an inner perimeter and height together defining a first cell volume, and further including adhesive layers on opposing sides of the first containment ring; disposing a first electrode plate adjacent to the first ring-shaped laminate; filling active particles into the first cell volume; providing a second ring-shaped laminate including a second containment ring having an inner perimeter and height together defining a second cell volume, the second containment ring having adhesive layers on opposing sides of the second containment ring; disposing a second electrode plate adjacent to the second ring-shaped laminate; filling active particles into the second cell volume; and assembling the first ring-shaped laminate and the second ring-shaped laminate on opposing sides of a separator such that the first electrode plate and the second electrode plate are on opposing sides of the assembly.

Further details of these and other embodiments and aspects of the invention are described more fully below, with reference to the attached drawing figures.

### BRIEF DESCRIPTION OF THE DRAWINGS

FIG. 1 illustrates a perspective view of an exploded configuration of a battery utilizing the technology of the present description, according to an embodiment.

FIG. 2 illustrates a perspective view of the battery of FIG. 1 in an assembled configuration, according to an embodiment.

FIG. 3A illustrates a side cross-sectional view of the battery of FIG. 2, as viewed along lines A-A, according to an embodiment.

FIG. 3B illustrates an enlarged view of a region B of FIG. 3A, according to an embodiment.

FIG. 4A through FIG. 4O illustrate a schematic diagram of a manufacturing process for the battery of FIGS. 1, 2, 3A and 3B, according to an embodiment.

FIG. 5 is a plot illustrating bench performance of a battery configured according to the present disclosure.

### DETAILED DESCRIPTION

Before discussing details of the high capacity small form factor battery of the present disclosure, a few conventions are provided for the convenience of the reader.

Various abbreviations may be used herein for standard units, such as deciliter (dl), milliliter (ml), microliter (μl), international unit (IU), centimeter (cm), millimeter (mm), nanometer (nm), inch (in), kilogram (kg), gram (gm), milligram (mg), microgram (μg), millimole (mM), degrees Celsius (° C.), degrees Fahrenheit (° F.), millitorr (mTorr), hour (hr), or minute (min).

When used in the present disclosure, the terms “e.g.,” “such as”, “for example”, “for an example”, “for another example”, “examples of”, “by way of example”, and “etc.” indicate that a list of one or more non-limiting example(s) precedes or follows; it is to be understood that other examples not listed are also within the scope of the present disclosure.

As used herein, the singular terms “a,” “an,” and “the” may include plural referents unless the context clearly dictates otherwise. Reference to an object in the singular is not intended to mean “one and only one” unless explicitly so stated, but rather “one or more.”

The term “in an embodiment” or a variation thereof (e.g., “in another embodiment” or “in one embodiment”) refers herein to use in one or more embodiments, and in no case limits the scope of the present disclosure to only the embodiment as illustrated and/or described. Accordingly, a component illustrated and/or described herein with respect to an embodiment can be omitted or can be used in another embodiment (e.g., in another embodiment illustrated and described herein, or in another embodiment within the scope of the present disclosure and not illustrated and/or not described herein).

The term “component” refers herein to one item of a set of one or more items that together make up a device, formulation or system under discussion. A component may be in a solid, powder, gel, plasma, fluid, gas, or other form. For example, a device may include multiple solid components which are assembled together to structure the device and may further include a liquid component that is disposed in the device. For another example, a formulation may include two or more powdered and/or fluid components which are mixed together to make the formulation.

The term “design” or a grammatical variation thereof (e.g., “designing” or “designed”) refers herein to characteristics intentionally incorporated into a design based on, for example, estimates of tolerances related to the design (e.g., component tolerances and/or manufacturing tolerances) and estimates of environmental conditions expected to be encountered by the design (e.g., temperature, humidity, external or internal ambient pressure, external or internal mechanical pressure, external or internal mechanical pressure stress, age of product, or shelf life, or, if the design is introduced into a body, physiology, body chemistry, biological composition of fluids or tissue, chemical composition of fluids or tissue, pH, species, diet, health, gender, age, ancestry, disease, or tissue damage); it is to be understood that actual tolerances and environmental conditions before and/or after delivery can affect such designed characteristics so that different components, devices, formulations, or systems with a same design can have different actual values with respect to those designed characteristics. Design encompasses also variations or modifications to the design, and design modifications implemented after manufacture.

The term “manufacture” or a grammatical variation thereof (e.g., “manufacturing” or “manufactured”) as related to a component, device, formulation, or system refers herein to making or assembling the component, device, formulation, or system. Manufacture may be wholly or in part by hand and/or wholly or in part in an automated fashion.

The term “structured” or a grammatical variation thereof (e.g., “structure” or “structuring”) refers herein to a component, device, formulation, or system that is manufactured according to a concept or design or variations thereof or modifications thereto (whether such variations or modifications occur before, during, or after manufacture) whether or not such concept or design is captured in a writing.

The terms “substantially” and “about” are used herein to describe and account for small variations. For example, when used in conjunction with a numerical value, the terms can refer to a variation in the value of less than or equal to ±10%, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, a range of numbers includes any number within the range, or any sub-range if the minimum and maximum numbers in the sub-range fall within the range. Thus, for example, “<9” can refer to any number less than nine, or any sub-range of numbers where the minimum of the sub-range is greater than or equal to zero and the maximum of the sub-range is less than nine. Ratios may also be presented herein in a range format. For example, a ratio in the range of about 1 to about 200 should be understood to include the explicitly recited limits of about 1 and about 200, and also to include individual ratios such as about 2, about 35, and about 74, and sub-ranges such as about 10 to about 50, about 20 to about 100, and so forth.

The discussion now continues with respect to high capacity small form factor batteries. Embodiments of the present description provide devices, systems, and methods of manufacture for a small form factor battery with high capacity per unit volume. The battery is implemented using nanopowders in dry form. The term nanopowder as used herein refers to a powdered material containing nanoparticles (e.g., amorphous or crystalline form) in nanometer scale.

The dry form nanopowder can be compacted into a desired shape prior to disposing the nanopowder in the battery, can be partially compacted prior to and partially compacted during or after disposing the nanopowder in the battery, or can be compacted during or after disposing the nanopowder in the battery.

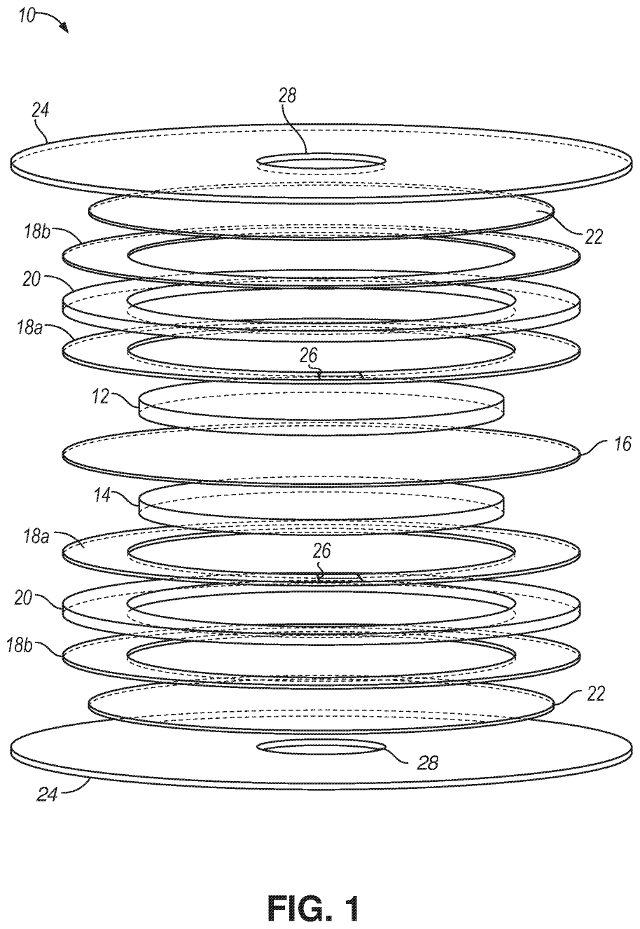

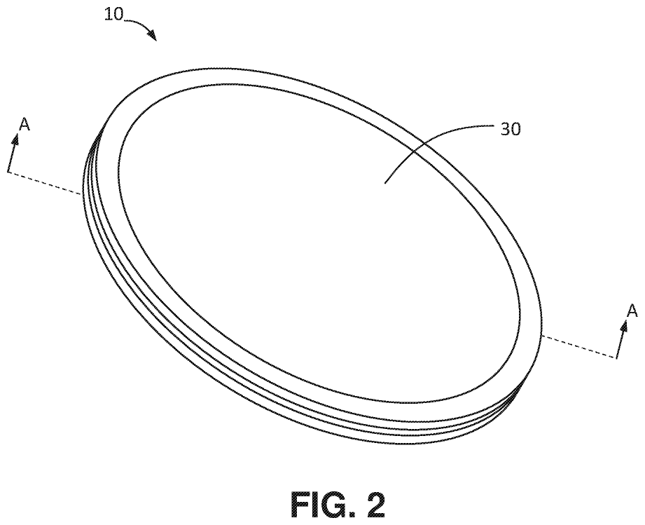

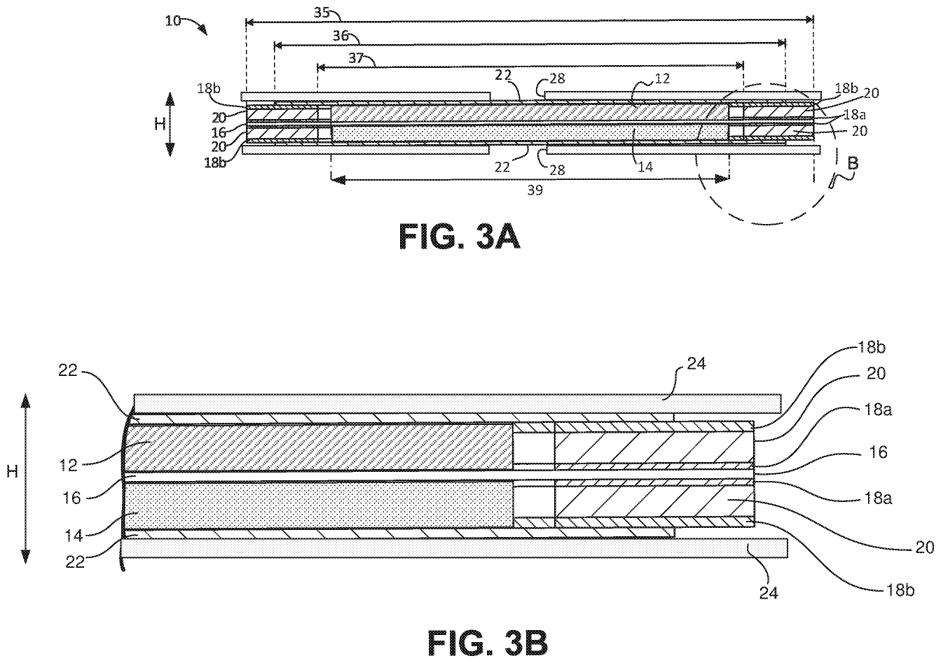

FIG. 1 illustrates a perspective view in an exploded configuration of a battery 10 utilizing the technology of the present description. Battery 10 as illustrated in FIG. 1 includes 13 layers; however more or fewer layers may be used. FIG. 2 illustrates an embodiment of battery 10 in an assembled configuration. FIG. 3A and FIG. 3B illustrate an embodiment of a configuration of battery 10 in a cross-sectional view.

Battery 10 is preferably sized to have a compact form factor (e.g., a thickness of about 0.5 mm and diameter of about 5 mm for the embodiment illustrated in FIG. 2). It is appreciated that battery 10 of the present description may be scaled to any number of sizes according to the particular application or use.

The circular outer shape of battery 10 illustrated in FIGS. 1, 2, 3A and 3B may be another shape as desired for a particular use. Examples of other shapes include rectangular, hexagonal, octagonal, other polygonal shape with or without equal-length sides, oval, or other regular or irregular shape. In an embodiment, a battery structured in a manner similar to battery 10 includes an opening extending through the entire assembly such that the battery may be positioned around a post or other protrusion or such that a component may be moved into or through the opening.

Referring to FIG. 1, battery 10 includes an anode cell and a cathode cell separated by a barrier layer. The anode cell and the cathode cell are each formed of a base cell structure defining a base cell volume, and dry, compacted active particles are disposed in the base cell volume. The base cell structure in the embodiment in FIG. 1 is a containment ring 20. The anode cell includes a first base cell structure 12 in which active particles are disposed. The cathode cell includes a second base cell structure 14 in which active particles are disposed. For each base cell structure, an inner adhesive layer 18a and an outer adhesive layer 18b are positioned on opposite sides of the containment ring 20.

In an embodiment, each base cell structure is provided as a ring-shaped laminate formed of an inner adhesive layer 18a and an outer adhesive layer 18b adhered on opposite sides of the containment ring 20, and the ring-shaped laminate defines the base cell volume in which active particles are disposed to form the anode cell or the cathode cell.

A separator 16 provides a barrier layer between the anode cell and the cathode cell. A first electrode plate 22 is positioned adjacent to the outer adhesive layer 18b of the anode cell and a second electrode plate 22 is positioned adjacent to the outer adhesive layer 18b of the cathode cell. An endplate 24 is positioned adjacent to each electrode plate 22.

In an embodiment, separator 16 includes porous material to allow passage of ions between the anode and cathode. In an embodiment, separator 16 includes porous material to allow passage of electrolyte between the anode and cathode. In an embodiment, separator 16 includes a hydrophilic material. In an embodiment, separator 16 includes a very thin film (e.g., 25.4 μm or 0.001 inch thick) including a hydrophilic, porous material. In an embodiment, separator 16 includes Cellophane P00 (from Futamura, USA Inc.). Separator 16 may include materials additional or alternative to those described above.

The active particles of the first or second base cell structures 12, 14 form an active component shape within battery 10 as manufactured (as indicated by respective disc shapes in the exploded view of FIG. 1), and the active component shape has a surface area which will be in contact with electrolyte.

In general, capacity of a battery may be increased by increasing a surface area of the active component shape, such as by increasing cell volume; however, this would be counter-indicative for the goal of decreasing dimensions of a battery.

As provided for in the present disclosure, capacity of battery 10 can be increased without increasing cell volume. The active component shapes formed by active particles 12 or 14 as disposed in battery 10 are limited by the cell volume of the base cell structure used; however, as described in the present disclosure, a surface area to volume ratio of individual active particles of first and/or second base cell structures 12, 14 themselves can increase capacity of battery 10. Accordingly, active particles of first and second base cell structures 12, 14 are very fine particles, which provides for a significant increase in surface area that a respective electrolyte will contact. In an embodiment, active particles of first and second base cell structures 12, 14 are dry, compacted particles having average particulate sizes of less than 1 μm.

Active particles of first and second base cell structures 12, 14 may be compacted before and/or after being disposed in a base cell volume to obtain the respective anode cell or cathode cell.

In an embodiment, active particles of first base cell structure 12 of the anode include silver oxide (e.g., Ag(I)O) powder having an average particulate size of less than 500 nm. While 500 nm is presently the smallest average particle size that is generally commercially available for Ag(I)O, it is appreciated that alternative forms of Ag(I)O may become commercially available, or a process may be developed, to obtain Ag(I)O having an average particle size that is less than 500 nm, and even significantly less. In addition to or alternative to Ag(I)O, other anode materials may also be employed as appropriate, particularly those available in or processable to nanopowder particulate size. The smaller the particle size, the larger the surface area to volume ratio of each particle becomes, and the more particles may be disposed in a given volume. Accordingly, the use of nanoparticles provides for an increase in total contact surface area between the active component and the electrolyte, and thus the higher the capacity of the battery.

In an embodiment, active particles of second base cell structure 14 of the cathode include a zinc powder having an average particulate size of less than 100 nm. As with active particles of first base cell structure 12, smaller average particle size nanoparticles (e.g., less than 50 nm) may be employed when and where available.

In an embodiment, active particles of second base cell structure 14 of the cathode include a zinc powder mixed with a polymeric binder to help bind the zinc powder and aid in handling and compression of the powder. In an embodiment, a composition of active particles of second base cell structure 14 is 90%-99% zinc with the remainder being a polymeric binder. For example, in an embodiment, a composition of active particles of second base cell structure 14 is 95% zinc and 5% polymeric binder; in an embodiment, a composition of such active particles is 95% zinc and 5% polyethylene oxide (PEO). In an example of a method of manufacture, the PEO is added to and mixed with the zinc powder in dry form, and then pressure is applied to the mixture, generating a pressure-induced binding of the zinc powder and PEO powder. In addition to or alternative to zinc and PEO, other cathode materials may also be employed as appropriate, particularly those available in or processable to nanopowder particulate size.

The battery configuration and methods of manufacture disclosed herein, although suited for formation of many types of batteries and for the use of many types of active components, are particularly adapted to accommodating dry nanoparticles of less than 50 nm. For example, the methods of manufacture disclosed herein is particularly suited to compacting and confining nanoparticles in a dry form (e.g., not in a slurry or in the presence of liquid or electrolyte) to fill the anode cell and the cathode cell with densely packed nanoparticles.

The layered structure of battery 10 is configured to aid in the manufacturing process, and specifically with distribution and compaction of the nanopowders of the anode and cathode in the small confines of the form factor of battery 10.

In an embodiment, one or both containment rings 20 include a thin polymeric layer that provides a moisture barrier which is also biochemically inert and chemically resistant.

In an embodiment, one or both containment rings 20 include a poly-chloro-trifluoroethylene (PCTFE) film (e.g., such as manufactured under tradename ACLAR, by HONEYWLL INTERNATIONAL, INC.).

In an embodiment, the containment rings 20 each have a design height of 101 μm (or about 0.004 in) and the active particles 12 or 14 are shown extending approximately to a height of the respective containment rings 20. In other embodiments, the containment rings 20 have a height less than 101 μm or greater than 101 μm to accommodate a desired mass and density of active particles of first or second base cell structures 12, 14. In an embodiment, the containment ring 20 of the anode cell has a different height than the containment ring 20 of the cathode cell.

The cathode cell and the anode cell are defined by the containment rings 20 and also by the shared separator 16 on one (inner) side and a pair of electrode plates 22 on the opposing (outer) sides. In an embodiment, the separator 16 has a design thickness of 25.4 μm. In an embodiment, each electrode has a design thickness of 25.4 μm. Other thicknesses of separator 16 and electrode plates 22 are also envisioned.

In an embodiment, containment rings 20 have an annular shape as illustrated in FIG. 1, a designed total particulate mass of the anode active particles and the cathode active particles together is 4 mg, the inner walls of the containment rings 20 (defining the respective cell volumes) have a design diameter of d=3.81 mm (or about 0.15 in), and each of the anode cell and the cathode cell has a design height of h=101 μm (e.g., the design volume V of each of the anode and cathode cells is V=πr2h=π(d)2h and the average density of active particles of first or second base cell structures 12, 14 is D=mass/2V). This embodiment is provided by way of example, and average density will vary depending on the specific materials of active particles of first and second base cell structures 12, 14, the size and shape of the basic cell structure used for the anode cell, the size and shape of the basic cell structure used for the cathode cell, and amount of compression used on active particles of first and/or second base cell structures 12, 14, among other variables. Further, depending on a variety of the same or different variables, density of active particles of first base cell structure 12 may differ significantly from the density of active particles second base structure 14, and density of active particles of the first and second base cell structures 12, 14 may differ significantly from the average density.

In an embodiment, at least one of the electrode plates includes nickel. Other metals or metal alloys or other conductive materials may be employed additionally or alternatively. In an embodiment, at least one of the electrode plates includes nickel coated on at least one side with silver.

In an embodiment, inner and outer adhesive layers 18a and 18b are positioned on opposing surfaces of containment rings 20. In the embodiment shown in FIG. 1, adhesive layers 18a and 18b have an annular shape. In an embodiment, adhesive layers 18a and 18b have a design thickness of 25.4 μm (or about 0.001 in); other thicknesses are also envisioned. As shown in FIG. 1, the inner adhesive layers 18a define one or more slots or ports 26 that aid with insertion of electrolyte into the cells, which insertion may be performed during manufacture of battery 10, or may be performed subsequent to a manufacturing of a battery 10 structure omitting electrolyte.

Adhesive layers 18a are configured to minimize movement of containment rings 20 against separator 16. Adhesive layers 18b are configured to minimize movement of containment rings 20 against electrode plates 22. In an embodiment, one or more sides of one or more of adhesive layers 18a and/or 18b have a high-friction surface to minimize movement. In an embodiment, one or more sides of one or more of adhesive layers 18a and/or 18b include an adhesive, which may include heat- or pressure-activated adhesive. In an embodiment, one or more sides of one or more of adhesive layers 18a and/or 18b include ethylene-vinyl acetate (EVA).

Battery 10 is capped with endplates 24, which may be electrically insulative and liquid-impermeable. In the configuration shown in the embodiment of FIG. 1, each endplate 24 includes an aperture 28 to provide for electrical contact with electrode plates 22, and in this embodiment the endplates 24 are annular such that the apertures 28 are approximately centered. Other configurations are also envisioned. While apertures 28 are shown in each endplate 24, in other embodiments a conductive tab (not shown) may extend from one of the electrode plates 22 along (e.g., outside, inside, or within) a housing or encapsulant of battery 10 to the endplate 24 adjacent to the other of the electrode plates 22 such that contact to both electrode plates 22 can be made through a single endplate 24 via one or more apertures 28.

FIG. 2 illustrates an embodiment in which battery 10 includes an encapsulant 30, which may be formed from a separate component or may be formed from endplate 24. In an embodiment, endplate 24 may include or have attached an insulative layer with adhesive backing (not shown), where the insulative layer has a larger diameter than electrode plate 22 and containment ring 20 so that it may drape over the various layers of battery 10 and be formed into an insulative barrier for battery 10. In an embodiment, both endplates 24 include or have attached such an insulative layer and, when draped, the insulative layers overlap each other and adhere to each other and/or to the layers of battery 10 to form an insulative barrier for battery 10. The insulative barrier as formed, however formed, may be pliable or may be non-pliable (e.g., firm or solid). In an embodiment, the insulative barrier forms an encapsulant that seals battery 10. In an embodiment, an encapsulant is formed over the insulative barrier. The encapsulant 30 may include one layer, or multiple layers of the same or different materials. In an embodiment, a material of an encapsulant includes a poly(vinylidene chloride) layer having one side coated with a chemically resistant adhesive layer. The encapsulant 30 preferably has high liquid impermeability and is chemically inert so as not to break down in the presence of chemicals. In an embodiment, battery 10 is configured to be implanted in the body or travel within a lumen of the body, and thus is configured to withstand and be biocompatible with body fluids, including acids or other fluids found in the gastrointestinal system.

FIG. 3A illustrates a cross-section view of the battery 10, along lines A-A of FIG. 2, according to one or more embodiments. FIG. 3B is an enlarged view of region B of FIG. 3A. As shown by FIG. 3A and FIG. 3B, the battery 10 includes a stacked concentric alignment of layers. The endplates 24 can form outer layers, and one or both of the endplates 24 can further be shaped or otherwise structured (e.g., combined with other materials) to form an encasement, so as to encase a thickness of the overall structure. The separator 16 separates layers of the battery 10 that form the anode cell from layers that form the cathode cell. The anode cell includes first base cell structure 12 concentrically disposed within containment ring 20. The inner adhesive layer 18a is disposed between containment ring 20 of the anode cell and the separator 16. The outer adhesive layer 18b is disposed between containment ring 20 and the electrode 22 for the anode cell. As described by some embodiments, the endplate 24 of the anode cell includes the aperture 28 to provide electrical access to the 22.

The cathode cell includes the second base structure 14, concentrically disposed with the containment ring 20. The cathode cell also includes outer adhesive layer 18b, disposed between the respective containment ring 20 and the separator 16. Additionally, the respective inner adhesive layer 18a is disposed between the containment ring 20 and the electrode 22 of the cathode cell. As described by some embodiments, the endplate 24 of the cathode cell can also include aperture 28 to provide electrical access to the respective electrode 22.

With reference to FIG. 3A, the concentric arrangement of the layers of the battery 10 are illustrated by the indicated lengths. The containment ring 20 includes a length (or diameter) 35, with length 37 representing the void of the interior of the containment ring 20. The electrodes 22 can include lengths 36, so as to extend over a portion of the containment ring. The first and second base cell structures 12, 14 for retaining the respective anode and cathode active particles has a length 39, which is less than the length 37 of the void, so that each of the base cell structures are concentrically retained within the corresponding containment ring of the respective anode and cathode cell.

As noted, particles may be compacted before or after being disposed in a base cell structure to form an anode cell or cathode cell. A layered structure such as battery 10 illustrated in FIG. 1, FIG. 3A or FIG. 3B is particularly suited for either technique. In an embodiment, particles are compacted to a desired shape and size and disposed in a base cell volume. In an embodiment, particles are compacted to an intermediate shape and size, disposed in a base cell volume, and further compacted within the base cell volume to fit the size and shape of the base cell volume. In an embodiment, particles are disposed in a base cell volume and compacted one or more times to obtain a desired density of the particles within the base cell volume; particles may be added between compactions in an embodiment.

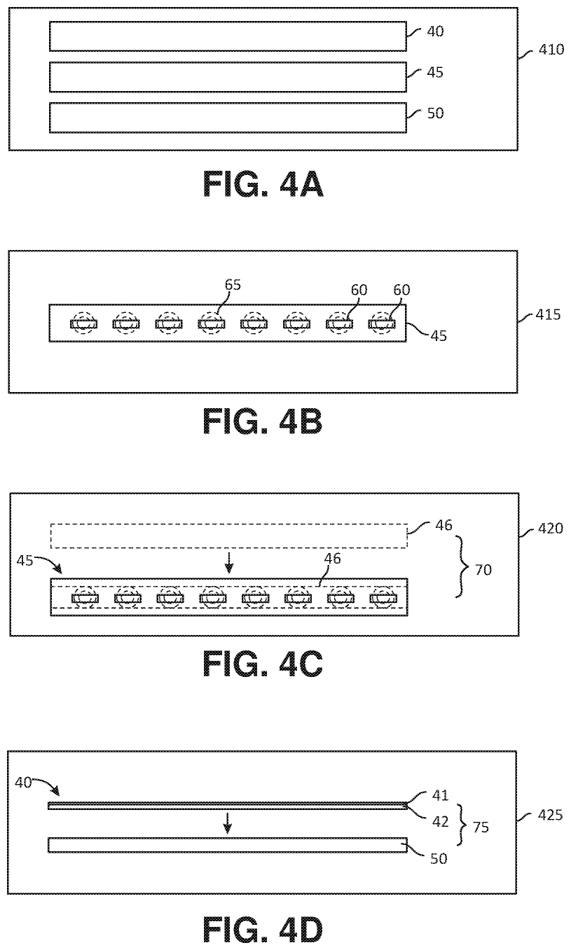

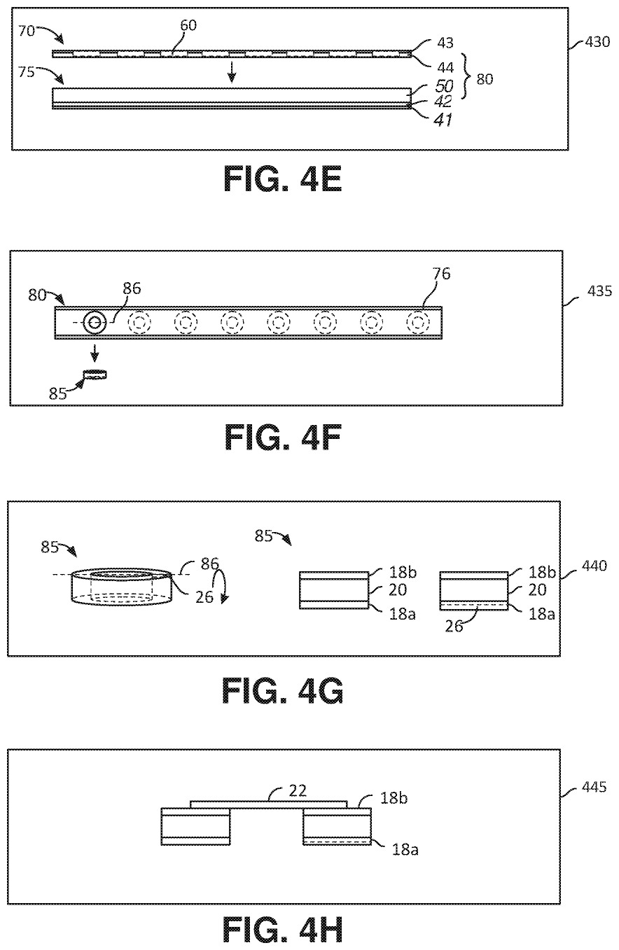

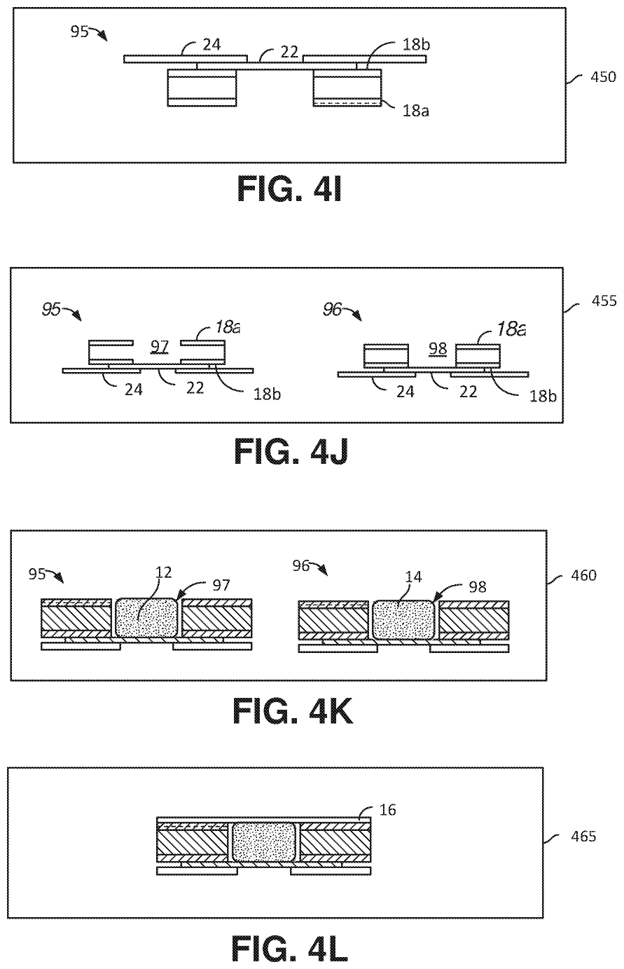

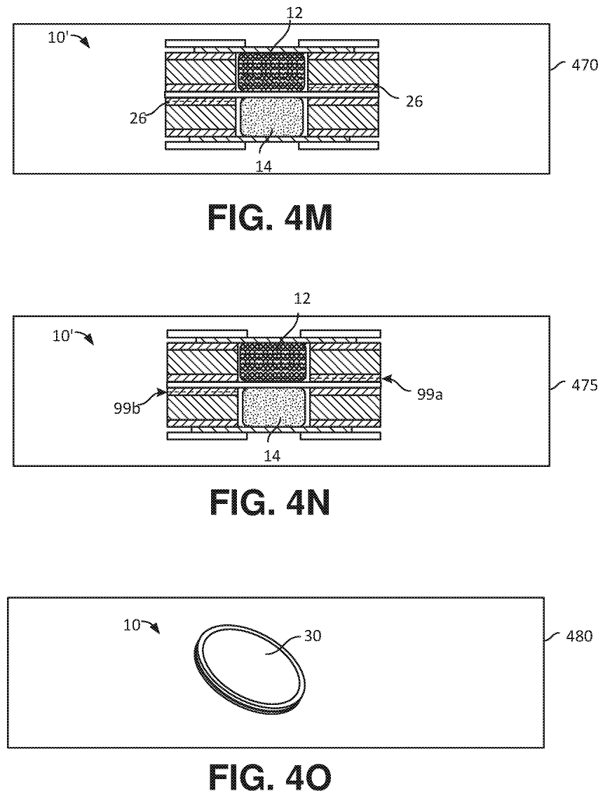

FIGS. 4A-40 illustrate a schematic diagram of an embodiment of a manufacturing process that may be implemented for manufacturing an embodiment of battery 10 of the present description.

FIG. 4A illustrates that at block 410, two sheets 40, 45 of adhesive layering and a sheet 50 of a structural material (which will form containment rings 20, e.g., a material such as manufactured under tradename ACLAR, by HONEYWLL INTERNATIONAL, INC) are provided. Sheets 40, 45, and 50 are shown from a top view. Although shown as having approximately the same dimensions from a top view, sheets 40, 45, 50 may not have the same dimensions; in an embodiment, sheets 40, 45, 50 do not have the same dimensions; in an embodiment, sheets 40, 45, 50 do not have the same dimensions and are cut to have the same dimensions prior to proceeding with process 400; in an embodiment, sheet 40 and sheet 45 represent different sections of a single sheet of adhesive layering. Although shown as being rectangular and having a length dimension much greater than a width dimension, sheets 40, 45, 50 may be any shape and have any dimensions.

FIG. 4B illustrates that at block 415, slots 60 are cut (e.g., by a laser cutting process) into one side of sheet 45 (slots 60 will become apertures 26 of battery 10). Sheet 45 is shown in top view. Slots 60 may extend partially or fully through sheet 45. Dashed annular ring 65 indicates one of multiple base cell structures that will be formed during process 400 (see, e.g., block 435 illustrating base cell structure 85). Although shown as a one row by eight column array of annular rings 65, more generally there may be multiple rows and multiple columns which may or may not be aligned. Slots 60 may extend fully across the to-be-formed base cell structure as indicated with respect to annular ring 65 (so as to form two apertures 26 on opposite sides of battery 10), or may instead extend only into the center portion of the annular ring (so as to form a single aperture 26 in battery 10). Other shapes of slot 60 are also envisioned (so as to form one or more apertures 26). For example, slots 60 may be Y-shaped or T-shaped (so as to form three apertures 26 in battery 10), cross-shaped or X-shaped (to form four apertures 26 in battery 10), star-shaped, or any other shape.

FIG. 4C illustrates that at block 420, to aid in preventing slots 60 from being filled during further processing, a thin sheet of heat resistant material 46 may be positioned to cover the slots. The material 46 may be removed at a later time during manufacture of battery 10 if desired. The combination of sheet 45 and material 46 forms an interim structure 70. In an embodiment, material 46 includes poly(vinyl alcohol) (PVA) which is hydrophilic so can act as a wick to promote ingress of electrolyte.

FIG. 4D illustrates that at block 425, as seen in side view, sheet 40 is positioned adjacent to sheet 50. Sheet 40 in this embodiment includes a backing 41 and an adhesive 42. In an embodiment, adhesive 42 is a heat-activated adhesive and heat is applied to backing 41 to adhere sheet 40 to sheet 50. In an embodiment, adhesive 42 is a pressure-activated adhesive and pressure is applied to backing 41 to adhere sheet 40 to sheet 50. The combination of sheet 40 and sheet 50 forms an interim structure 75.

FIG. 4E illustrates that at 430, interim structure 75 is turned over, and interim structure 70 is positioned adjacent to interim structure 75. Sheet 45 incorporated into interim structure 70 in this embodiment includes a backing 43 and an adhesive 44 (e.g., including EVA). In an embodiment, adhesive 44 is a heat-activated adhesive and heat is applied to backing 43 to adhere interim structure 70 to interim structure 75. In an embodiment, adhesive 44 is a pressure-activated adhesive and pressure is applied to backing 43 to adhere interim structure 70 to interim structure 75. The combination of interim structure 70 and interim structure 75 forms an interim structure 80.

FIG. 4F illustrates that at block 435, interim structure 80 is cut to form multiple base cell structures 85. In an embodiment, backings 41 and/or 43 are removed prior to cutting. In an embodiment, backings 41 and/or 43 are removed after cutting, either directly after or at a later stage of process 400.

FIG. 4G illustrates that at block 440, one base cell structure 85 is shown in perspective view on the left, and is shown flipped over in a planar view through line 86 on the right. Base cell structure 85 includes a containment ring 20 (formed from sheet 50) with an inner adhesive layer 18a (formed from interim structure 70) on one side and an outer adhesive layer 18b (formed from sheet 40) on the other side. One aperture 26 (formed by slots 60) extends from an outside perimeter to an inside perimeter of inner adhesive layer 18a. A single aperture 26 is shown for context; however, additional apertures 26 may be included as desired as discussed above. In this embodiment, aperture 26 does not extend through a thickness of inner adhesive layer 18a.

FIG. 4H illustrates that at block 445, an electrode plate 22 is adhered to a first base cell structure 85.

FIG. 41 illustrates that at block 450, an endplate 24 is positioned or adhered adjacent to electrode plate 22 to form a subassembly 95. Two instances of subassembly 95 will be used in the embodiment of process 400 to form battery 10, referred to as subassembly 95 and subassembly 96. In other embodiments, subassembly 95 and subassembly 96 are not structured following the same design. In an embodiment, subassembly 95 and/or subassembly 96 are procured already assembled as shown in block 450 and then are combined to form battery 10.

FIG. 4J illustrates that at block 455, subassemblies 95 and 96 are inverted. Subassembly 95 defines a cavity 97 and subassembly 96 defines a cavity 98.

FIG. 4K illustrates that at block 460, cavity 97 is filled with active particles (e.g., a nanopowder of silver oxide) to form an anode cell and cavity 98 is filled with active particles (e.g., a nanopowder including zinc) to form a cathode cell. If disposed in powder form, active particles for the anode cell and/or active particles of the cathode cell are tamped and/or compacted to approximately uniformly fill respective cavity 97 and/or cavity 98.

FIG. 4L illustrates that at block 465, a separator 16 is disposed on and may be adhered to adhesive layer 18a of either subassembly 95 or subassembly 96 on a side opposite electrode plate 22.

FIG. 4M illustrates that at block 470, subassembly 95 and subassembly 96 are joined together with separator 16 between them in a manner such that adhesive layers 18a of both subassemblies 95, 96 are adjacent to separator 16, to form a battery 10′.

For adhesive layers 18a, 18b which are heat-activated or pressure-activated, heat or pressure respectively may be employed at one or more stages of process 400 where desired, including at block 470.

FIG. 4N illustrates that at block 475, an electrolyte 99a is introduced into the anode cell, to obtain an anode, and an electrolyte 99b is introduced into the cathode cell, to obtain a cathode. Electrolyte 99a and electrolyte 99b may be the same or different substances. In an embodiment electrolytes 99a and 99b are the same substance, potassium hydroxide flakes (caustic potash anhydrous KOH dry, 84-92%) mixed with water in a ratio of 100 μl water to 82 gm KOH.

In an embodiment, electrolyte 99a and/or electrolyte 99b is introduced by injection. In an embodiment, the dry assembly of battery 10′ (block 470) is subjected to a vacuum and then immersed in electrolyte 99a or 99b as the vacuum is removed so that electrolyte 99a or 99b is drawn into the anode cell and/or cathode cell.

In embodiments in which adhesive layer 18a is or includes a hydrophilic material (e.g., adhesive layer 18a includes PVA), the hydrophilic material may promote ingress of electrolyte 99a and/or electrolyte 99b by a wicking action through the small confines of apertures 26.

Battery 10′ may optionally be stored in a dry state for a period of time without electrolyte 99a and/or without electrolyte 99b. Prior to use, the electrolyte is then introduced.

FIG. 4O illustrates that at block 480, an encapsulant 30 such as described with respect to FIG. 2 is disposed over battery 10′ to form battery 10. Battery 10 may include ports (not shown) to allow for accessing apertures 26 to introduce electrolyte 99a and/or 99b subsequent to encapsulation.

As can be seen by process 400, generation of multiple (e.g., n=36, n=64, n=80, n=500, or more) separate components or multiple base cell structures may (but not necessarily) be formed concurrently.

Process 400 may be varied or modified. For example, apertures 26 may be generated in either of the adhesive layers 18a or 18b, the cathode cells or the anode cells may be generated sequentially or contemporaneously, or a base cell structure may be attached to the separator before being filled with active particles.

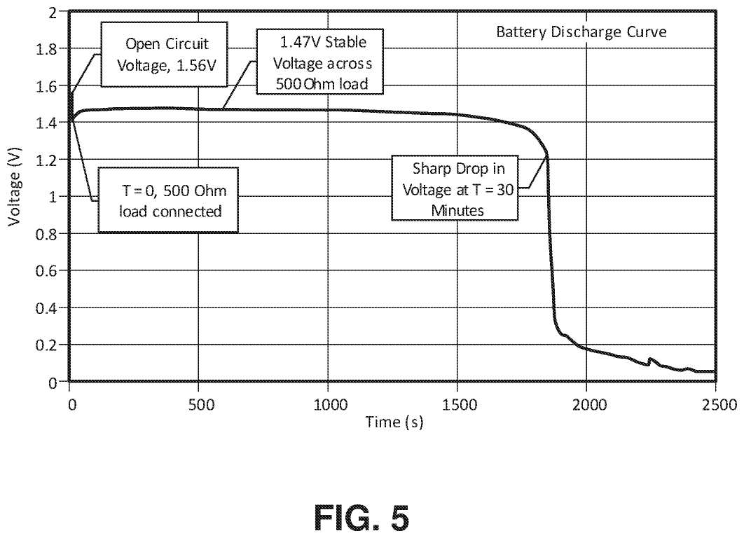

FIG. 5 shows an example of a battery discharge curve, illustrating bench performance of a battery structured according to the present description. The open circuit voltage of the battery was 1.56 V. The curve in FIG. 5 shows a stable voltage of 1.47 Volts (V) across a 500 ohm load for a time period of approximately 30 minutes, indicating a battery capacity of approximately 1.47 milliampere hours (mA-h) or approximately 5.29 Coulombs. These results were achieved in a small form factor battery with diminutive outer dimensions of approximately 5.08 mm diameter and approximately 381 μm height (omitting end caps 22 and the encapsulant or housing).

In a bench test of another battery structured in accordance with the present description, the battery output was approximately 10 mA in a small form factor battery with diminutive outer dimensions of approximately 5.08 mm diameter and approximately 381 μm height (omitting end caps 22 and the encapsulant or housing).

An embodiment of a battery structured in accordance with the present description met the following requirements given for a specific application: voltage equal to or greater than 1.2 Volts, current equal to or greater than 10 mA with a 500 Ohm load, capacity of 0.5 mA-h or greater, and a form factor with less than 5.08 mm diameter and less than 381 μm height.

The foregoing description of various embodiments of the invention has been presented for purposes of illustration and description. It is not intended to limit the invention to the precise forms disclosed. Many modifications, variations and refinements will be apparent to practitioners skilled in the art. For example, embodiments of the device can be sized and otherwise adapted for various applications. Also, those skilled in the art will recognize, or be able to ascertain using no more than routine experimentation, numerous equivalents to the specific devices and methods described herein. Such equivalents are considered to be within the scope of the present invention and are covered by the appended claims below.

Elements, characteristics, or acts from one embodiment can be readily recombined or substituted with one or more elements, characteristics or acts from other embodiments to form numerous additional embodiments within the scope of the invention. Moreover, elements that are shown or described as being combined with other elements, can, in various embodiments, exist as standalone elements. Hence, the scope of the present invention is not limited to the specifics of the described embodiments, but is instead limited solely by the appended claims.

What is claimed is:

1. A small form factor battery, comprising:
an anode cell comprising a first containment ring defining an opening therethrough and a wall of the first containment ring around the opening defining an anode cell volume, the first containment ring comprising a liquid-impermeable material;
a cathode cell comprising a second containment ring defining an opening therethrough and a wall of the second containment ring around the opening defining a cathode cell volume, the second containment ring comprising a liquid-impermeable material;
anode active particles disposed in the anode cell volume and having an average particle size of less than 1 μm;
cathode active particles disposed in the cathode cell volume and having an average particle size of less than 1 μm;
a separator disposed between the anode cell and the cathode cell; and
two electrode plates, one disposed on the anode cell opposite the separator and one disposed on the cathode cell opposite the separator.

2. The battery of claim 1, wherein the anode active particles and the cathode active particles have an average particle size of less than 500 nm.

3. The battery of claim 2, wherein the anode active particles or the cathode active particles have an average particle size of less than 100 nm.

4. The battery of claim 2, wherein the anode active particles or the cathode active particles have an average particle size of less than 50 nm.

5. The battery of claim 2, wherein the anode active particles comprise silver oxide.

6. The battery of claim 2, wherein the cathode active particles comprise zinc.

7. The battery of claim 6, wherein the cathode active particles further comprise a polymeric binder.

8. The battery of claim 7, wherein the active particles contained within the cathode cell volume comprise 90%-99% zinc with the remainder being a polymeric binder.

9. The battery of claim 1, wherein the anode active particles or the cathode active particles are compacted and in a dry form.

10. The battery of claim 1, wherein a total particulate mass of the anode and cathode active particles is equal to or less than 4 mg, and the openings defined by the first and second containment rings each have a 3.81 mm diameter and about 101 μm height.

11. The battery of claim 1, further comprising one or more ports for adding electrolyte.

12. The battery of claim 1, further comprising an insulative encapsulating layer.

13. The battery of claim 1, wherein the cathode containment ring and/or the anode containment ring comprises a polymeric layer that provides a moisture barrier while being biochemically inert and chemically resistant.

14. The battery of claim 13, wherein the polymeric layer comprises poly-chloro-trifluoroethylene (PCTFE) film.

15. The battery of claim 1, wherein the form factor of the battery comprises an outer perimeter diameter of less than about 5.1 mm and a thickness of less than 381 μm.

16. A method of manufacturing a small form factor battery, comprising:
providing a first ring-shaped laminate including a first containment ring having an inner perimeter and height together defining a first cell volume, and further including adhesive layers on opposing sides of the first containment ring;
disposing a first electrode plate adjacent to the first ring-shaped laminate;
filling first active particles into the first cell volume;
providing a second ring-shaped laminate including a second containment ring having an inner perimeter and height together defining a second cell volume, the second containment ring having adhesive layers on opposing sides of the second containment ring;
disposing a second electrode plate adjacent to the second ring-shaped laminate;
filling second active particles into the second cell volume; and
assembling the first ring-shaped laminate and the second ring-shaped laminate on opposing sides of a separator such that the first electrode plate and the second electrode plate are on opposing sides of the assembly.

17. The method of claim 16, wherein the first active particles and the second active particles have an average particle size of less than 500 nm.

18. The method of claim 16, wherein the first active particles or the second active particles have an average particle size of less than 100 nm.

19. The method of claim 16, wherein the first active particles or the second active particles have an average particle size of less than 50 nm.

20. The method of claim 16, wherein the first active particles volume comprises silver oxide.

21. The method of claim 16, wherein the second active particles comprise zinc.

22. The method of claim 21, wherein the second active particles further comprise a polymeric binder.

23. The method of claim 22, wherein the second active particles comprise 90%-99% zinc with the remainder being a polymeric binder.

24. The method of claim 16, further comprising compacting the first active particles and the second active particles in a dry form.

25. The method of claim 16, wherein a total particulate mass of the first and second active particles is equal to or less than 4 mg, and the first and second cell volumes are defined by a 3,81 mm diameter cell perimeter and 127 μm cell height.
